(19) United States
(12) Patent Application Publication
(10) Pub. No.: US 2014/0020501 A1
(43) Pub. Date: Jan. 23, 2014

(54) Angular Contact Ball Bearing Assembly For Use In A Steering Column

(71) Applicant: Aktiebolaget SKF, Goteborg (SE)

(72) Inventors: Sylvain Bussit, Monnaie (FR); Daniel Jansen, Tours (FR); Thomas Lepine, Villandry (FR); Bruno Montboeuf, Cerelles (FR)

(73) Assignee: Aktiebolaget SKF, Goteborg (SE)

(21) Appl. No.: 13/945,996

(22) Filed: Jul. 19, 2013

(30) Foreign Application Priority Data
Jul. 20, 2012 (EP) 12290240.6

(51) Int. Cl. B62D 1/16; F16C 33/30

(52) U.S. Cl. CPC B62D 1/16; F16C 33/30
USPC 74/492; 384/456

(57) ABSTRACT

The angular contact bearing assembly for use in a steering column according to the invention comprises in particular a conductive inner ring with a concave recess forming a first raceway, a conductive outer ring with a concave recess forming a second raceway, a set of conductive balls contacting both the first raceway and the second raceway, a sleeve for mounting the conductive inner ring on a shaft; and at least one conductive part creating an electrically conductive contact between the inner ring and the shaft. It is proposed that the conductive part has a circumferential extension of less than 360° and does not have a main body in the shape of (or topologically equivalent to) a full ring.

### CROSS-REFERENCE TO RELATED APPLICATION

This application is a United States Non-Provisional Utility Patent Application claiming the benefit of European Patent Application Number 12290240.6 filed on 20 Jul. 2012, which is incorporated herein in its entirety.

### TECHNICAL FIELD

The invention relates to an angular contact bearing assembly in a steering column.

### BACKGROUND ART

Steering columns in automobiles are generally equipped with angular contact ball bearing assemblies comprising a conductive inner ring with a concave recess forming a first raceway, a conductive outer ring with a concave recess forming a second raceway and a set of conductive balls contacting both the first raceway and the second raceway. In order to simplify the mounting of the inner ring on a central shaft of the steering column, the inner ring is mounted on the shaft via a sleeve or tolerance ring, which is usually molded of non-conductive plastics in order to allow for some flexibility and to reduce the costs.

Steering wheels mounted on the shaft often contain electrical switches or devices and or airbags, which may be affected by electrostatic charges accumulating on the steering wheel.

It is therefore important to ensure an electrical grounding of the steering wheel by ensuring a conductive contact between the shaft of the steering column and the chassis of the automobile via the angular ball bearings. As a matter of course, this conductive contact could be used for transmitting electrical signals as well.

The document U.S. Pat. No. 4,530,609 teaches to make the sleeve conductive by using a graphite-filled polymer material, which is, however, fairly expensive.

In order to provide this electrical contact, the document FR 2782758 A1 teaches to use a conductive part creating an electrically conductive contact between the inner ring and the shaft. This conductive part is a generally ring-shaped member arranged between an axial end face of the sleeve and a wavy spring or ondular washer generating an axial preload of the angular bearing. The wavy spring is preloaded with a fixing ring fitted over the shaft. The ring-shaped member is provided with a ring-shaped main body and a latch or tongue bent around the profile of the sleeve so as to overlap with a surface supporting the inner ring such that the inner ring is in contact with the latch. The electrically conductive contact between the outer ring and the shaft is therefore established from the outer ring via the balls, the inner ring, the latch, the main body of the ring-shaped member, the wavy spring, and the fixing ring.

A similar solution with a conductive element having a ring-shaped main body and multiple latch-like axial protrusions engaging in slots of the sleeve is proposed in the document U.S. Pat. No. 6,675,360 B1.

A solution where the latches are immediately formed on the wavy spring is proposed in US 2010/0308569A1. A solution where latches are formed integrally with the inner ring is proposed in DE 102 20 688 B4.

In this conductive pathway, there is a high number of contact points which are susceptible to degradation or interruption of the contact and the total probability of failure accumulates the individual probabilities. Further, the latch part of the conductive part may break off from the ring-shaped main body of the conductive part during the assembly such that the conductive pathway will not be established. The loose latch may cause further problems in the assembly procedure.

### DISCLOSURE OF INVENTION

The invention has been made in an attempt to solve these problems and proposes an angular contact bearing assembly comprising:

at least one rolling bearing comprising conductive components;

a sleeve for mounting the at least one conductive rolling bearing on a shaft; and

at least one conductive part creating an electrically conductive contact between at least one of the conductive components of the at least one rolling bearing and the shaft,

wherein said conductive part has a circumferential extension of less than 360°.

The angular contact bearing assembly for use in a steering column according to the invention comprises in particular at least one rolling bearing comprising conductive components, a sleeve for mounting the at least one conductive rolling bearing on a shaft; and at least one conductive part creating an electrically conductive contact between one of the conductive components and the shaft. It is proposed that the conductive part has a circumferential extension of less than 360° and does not have a main body in the shape of (or topologically equivalent) to a full ring. The expression “circumferential extension” refers to a circumference of a rotation axis of the shaft of the steering column.

The open topology of the conductive part increases the flexibility thereof and reduces the risk that essential elements of the conductive part break off during the assembly procedure or during the use of the angular contact bearing assembly. As a consequence, the failure probability may be considerably reduced.

Preferably, the conductive components of the at least one rolling bearing include a conductive inner ring with a concave recess forming a first raceway, a conductive outer ring with a concave recess forming a second raceway, and a set of conductive balls contacting both the first raceway and the second raceway.

It is further proposed that the conductive part has a circumferential extension of less than 90°, more preferably less than 30° and in particular less than 5°. The smaller the circumferential extension is, the smaller is the probability and the typical amplitude of deformations during the assembly and, as a consequence, the smaller the probability of failures.

The fact that this specification refers to the circumferential extension of the conductive part does not mean that this part has a curvature or is arc-shaped in the circumferential direction. Rather, the contacting portion if the conductive part is preferably bent out of a flat, band-like metal part and arranged tangentially with respect to the symmetry- and rotation axis of the shaft. In other words, the conductive part has a linear/plan shape in a radial cut section. Alternatively, the conductive part has a rounded/arc-circle shape in a radial cut section.

It is to be noted that the requirement of a circumferential extension of the conductive part implies any curvature of this part in the circumferential direction. Rather, the contact portion of the conductive part may be flat and arranged tangentially with respect to the surface on which it abuts.

In a preferred embodiment of the invention, the conductive part is formed as a clip snapped on a brim of the sleeve. This facilitates the assembly and reduces the amount of material needed for the conductive part such that the overall costs of the angular contact bearing assembly may be reduced.

If the sleeve is provided with a recess with a circumferential extension corresponding to the circumferential extension of the conductive part, the clip may be secured in the circumferential direction, an unconscious shifting or loosening of the clip may be avoided, and the probability of failures may be further reduced.

Similar advantages may be achieved when the angular contact bearing assembly comprises an axial recess in a brim of the sleeve in addition to a recess in the circumferentially outer or inner surface of the sleeve or instead of such a recess.

It is further proposed that the recess extends from a radially inner surface of the sleeve to a radially outer surface of the sleeve, wherein the radially inner surface is configured to be fitted over a shaft and the radially outer surface is configured to support the conductive inner ring. In this configuration, the conductive part may be almost completely arranged in the recess so as to provide a good protection against loosening during the assembly, wherein only the contact points designed to establish the contact to the inner ring and/or to the shaft should protrude from the recess.

The failure probability may be further reduced by means of redundancy by providing the assembly with multiple conductive parts distributed over the circumference of the sleeve. Preferably, these multiple conductive parts have an identical shape.

Preferably, the conductive part is provided with a first flexible portion contacting the conductive inner ring, wherein said first flexible portion is configured such that it is deformed and preloaded when fitting the conductive inner ring over the sleeve. This flexibility may provide for some tolerance on the one hand and result in a preload of the contact points on the other hand such that the failure probability may be further reduced.

Similar advantages may be achieved if the conductive part is provided with a second flexible portion configured to contact the shaft, wherein said second flexible portion is configured such that it is deformed and preloaded when fitting the assembly including the sleeve and the conductive part over the shaft. This second flexible part may be provided in addition to the first flexible part or independent from this part.

Preferably, the first flexible portion is mechanically connected to the second flexible portion in such a way that pressure acting on the first portion is transferred to the second portion and vice versa.

According to one aspect of the invention, the conductive part has a generally C-shaped body part configured to be snapped on a brim or into a recess of the sleeve, wherein at least one of the first and the second flexible portion is formed as a tongue or latch protruding from one end of the body part. In this configuration, the C-shaped body part may ensure a good fixation on the sleeve, whereas a good electrical contact may be ensured by the tongue or latch. This separation of the functions enables an independent optimization of the respective parts of the conductive part.

It is further proposed that the conductive part is generally strip-shaped and is provided with an anchor portion in which the width of the strip is increased as compared to other portions of the conductive part, wherein a recess having a neck portion is provided in the sleeve, the width of the neck portion corresponding to the width of said other portions of the conductive part. This enables a secure anchoring of the conductive part in the sleeve and avoids an undesired slipping-off.

It is further proposed that the angular contact ball bearing is configured such that the conductive part has a generally T-shaped structure wherein a transversal bar forms the anchoring portion.

A further aspect of the invention proposes a steering column for an automotive vehicle comprising a chassis with a mounting support, a shaft and at least one angular contact bearing assembly as discussed above, wherein the angular contact bearing assembly is mounted on the chassis mounting support and supporting the shaft.

The above embodiments of the invention as well as the appended claims and figures show multiple characterizing features of the invention in specific and non-limiting combinations. The skilled person will easily be able to consider further combinations or sub-combinations of these features in order to adapt the invention as defined in the claims to his or her specific needs.

### BRIEF DESCRIPTION OF DRAWINGS

The invention will be better understood on reading the description which will follow, given solely by way of non-limiting example and made with reference to the attached drawings in which:

FIG. 1 is a schematic view of a steering column with an angular contact bearing assembly according to the invention;

FIG. 2 is a perspective view of a sleeve of the angular contact bearing assembly of FIG. 1;

FIGS. 3a-3c are different views of a clip-like conductive part of the angular contact bearing assembly of FIG. 1;

FIG. 4 is a sectional view of the angular contact bearing assembly with the sleeve and the conductive part of FIGS. 2 and 3;

FIGS. 5a-5c are different views of a clip-like conductive part of the angular contact bearing assembly according to a second embodiment of the invention;

FIG. 6 is a sectional view of the angular contact bearing assembly with the conductive part of FIGS. 5a-5c;

FIGS. 7a-7c are different views of a clip-like conductive part of the angular contact bearing assembly according to a third embodiment of the invention;

FIG. 8 is a perspective view of a sleeve of an angular contact bearing assembly with the conductive part of FIGS. 7a-7c;

FIGS. 9a-9c are different views of a clip-like conductive part of the angular contact bearing assembly according to a fourth embodiment of the invention;

FIG. 10 is a perspective view of a sleeve of an angular contact bearing assembly with the conductive part of FIGS. 9a-9c;

FIGS. 11a-11c are different views of the sleeve according to FIG. 10;

FIG. 12 is a sectional view the angular contact bearing assembly with a conductive part according to the fourth embodiment of the invention;

FIGS. 13a-13c are different views of a clip-like conductive part of the angular contact bearing assembly according to a fifth embodiment of the invention;

FIG. 14 is a perspective view of a sleeve of an angular contact bearing assembly with the conductive part of FIGS. 13a-13c;

FIG. 15 is a sectional view the angular contact bearing assembly with a conductive part according to the fifth embodiment of the invention;

FIGS. 16a-16c are different views of a clip-like conductive part of the angular contact bearing assembly according to a sixth embodiment of the invention; and

FIG. 17 is a sectional view the angular contact bearing assembly with a conductive part according to the sixth embodiment of the invention.

### DETAILED DESCRIPTION

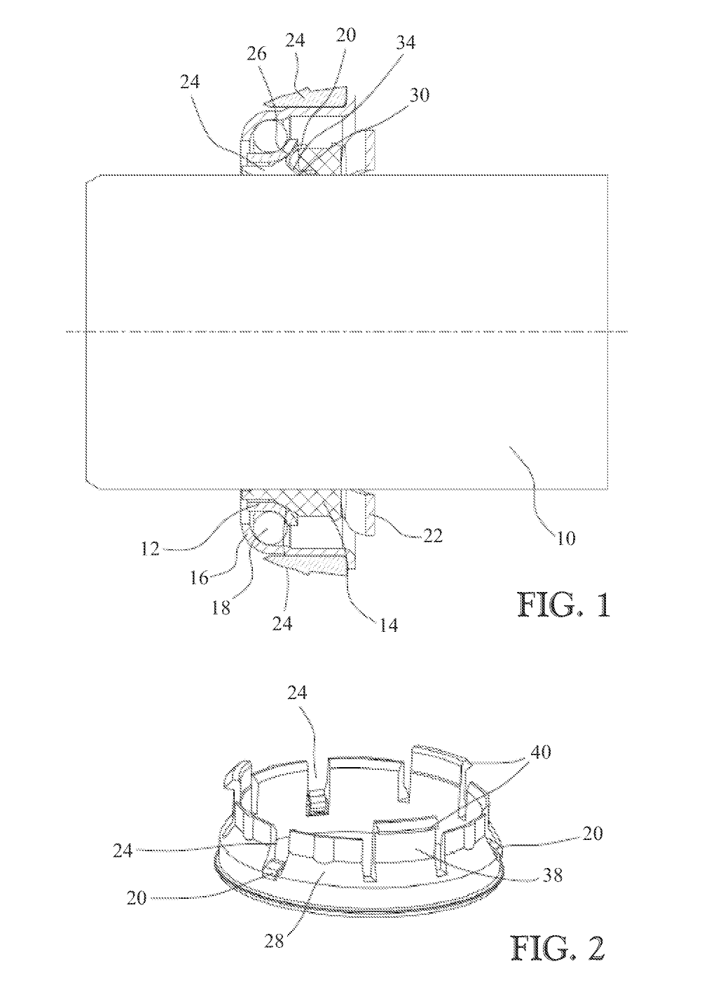

FIG. 1 is a schematic sectional view of an angular contact bearing assembly in a steering column of an automobile. The bearing assembly is mounted on a central shaft 10 connecting a steering wheel with steering rods (not shown).

The angular contact bearing assembly comprises a rolling bearing having conductive components. In particular, the rolling bearing comprises a conductive inner ring 12 with a concave recess forming a first raceway. The inner ring 12 is formed as a stamped and hardened sheet-metal piece in the illustrated embodiment, but could be made massive in the alternative.

The inner ring 12 is mounted on the shaft 10 via a plastic sleeve 14 contacting a conical inner surface of the inner ring 12 and has a certain elasticity such that the inner surface of the sleeve 14 is deformed radially inward when the inner ring 12 is pressed on the sleeve 14 such that a force-fitting connection between the inner ring 12 and the sleeve 14 is established.

Further, the angular contact bearing assembly comprises a conductive outer ring 16 with a concave recess forming a second raceway and being mounted in electrical contact with the chassis and the grounding of the automobile. The outer ring 16 is formed as a stamped a hardened sheet-metal piece in the illustrated embodiment, but could be made massive in the alternative.

The outer ring 16 is mounted in a chassis mounting support 42 of a steering column of an automotive vehicle.

A set of conductive balls 18 contacting both the first raceway and the second raceway is guided in a cage 40 (FIG. 4) and establishes an electrically conductive contact between the inner ring 12 and the outer ring 16.

As the sleeve 14 is non-conductive, a means for creating an electrically conductive contact between the inner ring 12 and the shaft 10 is needed on order enable a discharging of static electricity from the shaft 10 to the chassis of the automobile because accumulating static electricity could affect the function of electrical or electronic elements arranged on the steering wheel and/or electrical shocks.

In order to create this electrically conductive contact, the invention proposes to provide least one conductive part 20 creating an electrically conductive contact between the inner ring 12 and the shaft 10. In contrast to other known conductive parts of this type, the conductive part 20 is not provided with a ring-shaped main body, i.e. has a circumferential extension with reference to the rotation axis of the shaft 10 of less than 360°.

In the embodiment of FIGS. 1-4, three identical conductive parts 20 are provided which are formed as a clip snapped on a brim of the sleeve 14 respectively. The circumferential extension of this clip or the angular range as referred to the central axis of the shaft 10 covered by this clip is clearly less than 10° , even less than 5°.

The angular contact ball bearing is preloaded with a corrugated or wavy spring 22 or an ondular washer abutting to an axial end face of the sleeve 14 in order to generate an axial preload of the angular contact bearing assembly. The wavy spring 22 is a part separate from the conductive part 20 and made of elastic steel, whereas the conductive part 20 may optionally be coated with or made of copper or other highly conductive materials.

FIG. 2 is a perspective view of the sleeve 14 of the angular contact bearing assembly of FIG. 1. The sleeve 14 is provided with three recesses 24 with a circumferential extension or width slightly wider than the circumferential extension of the conductive part 20. The recesses 24 are large enough to enable a free movement of the conductive part 20 in the radial and axial directions.

The recess 24 comprises an axial recess in a brim of the sleeve 14 and extends from a radially inner surface 32 of the sleeve 14 to a radially outer surface 28 of the sleeve 14, wherein the radially inner surface 32 is configured to be fitted over a shaft 10 and the radially outer surface 28 is configured to support the conductive inner ring 12. Though the first embodiment illustrated here is provided with three conductive parts 20, it is clearly possible to use more or less conductive parts 20 distributed over the circumference of the sleeve 14 and clipped in pertinent recesses respectively. The brim is provided with further axial slots creating radially flexible latches 38. Three of the latches are provided with snap-fitting protrusions 40 projecting radially outward and having a chamfered end-face. The snap-fitting protrusions 40 will snap over an axially outer edge of the outer ring 16 such that the sleeve 14 loosely fixes the inner ring 12 to the outer ring 16.

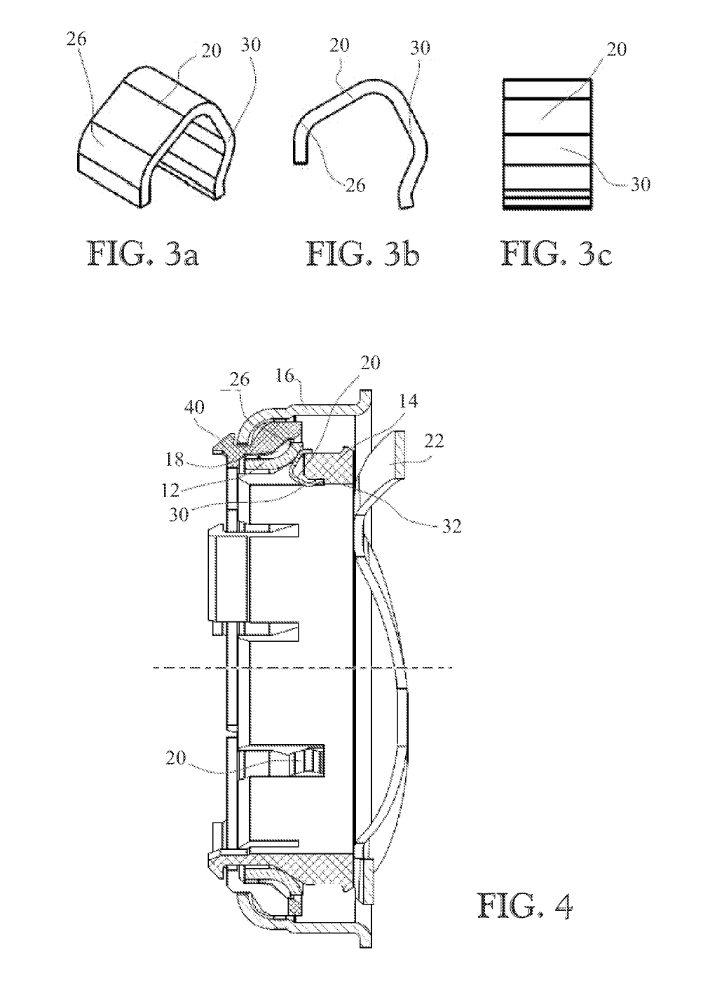

FIGS. 3a, 3b and 3c illustrate different views of the conductive part 20 prior to assembly and FIG. 4 shows the sleeve 14 and the conductive part 20 if the first embodiment in an assembled state. The conductive part 20 is provided with a first flexible portion 26 contacting the conductive inner ring 12, wherein said first flexible portion 26 is configured such that it is deformed and preloaded when fitting the conductive inner ring 12 over the sleeve 14. This means that the first flexible portion 26 projects radially and axially over the conical outer surface 28 of the sleeve 14 in the non-preloaded state prior to fitting the inner ring 12 onto the assembly.

In a similar way, the conductive part 20 is provided with a second flexible portion 30 configured to contact the shaft 10, wherein said second flexible portion 30 is configured such that it is deformed and preloaded when fitting the assembly including the sleeve 14 and the conductive part 20 over the shaft 10. In other words, the second flexible portion 30 projects radially inward over the cylindrical inner surface 32 of the sleeve 14 in the unpreloaded state prior to fitting the sleeve 14 onto the shaft 10 and is pushed radially outward when the shaft 10 is pushed into the assembly from the left hand side in FIG. 4.

The conductive part 20 has a generally C-shaped body part configured to be snapped on a brim or into one of the recesses 24 of the sleeve 14.

The assembly is illustrated in its mounted configuration in the sectional view of FIG. 1. Since pressure is exerted on both the first flexible portion 26 and the second flexible portion of the conductive part 20, the conductive part 20 is compressed radially such that its central part is lifted off the bottom of the recess 24 in the sleeve. The elastic restoring force of the conductive part 20 generates a contact pressure by which the first flexible portion 26 and the second flexible portion of the conductive part 20 are strongly pressed against the shaft 10 and the inner ring 12 respectively such that a good electrical contact is ensured.

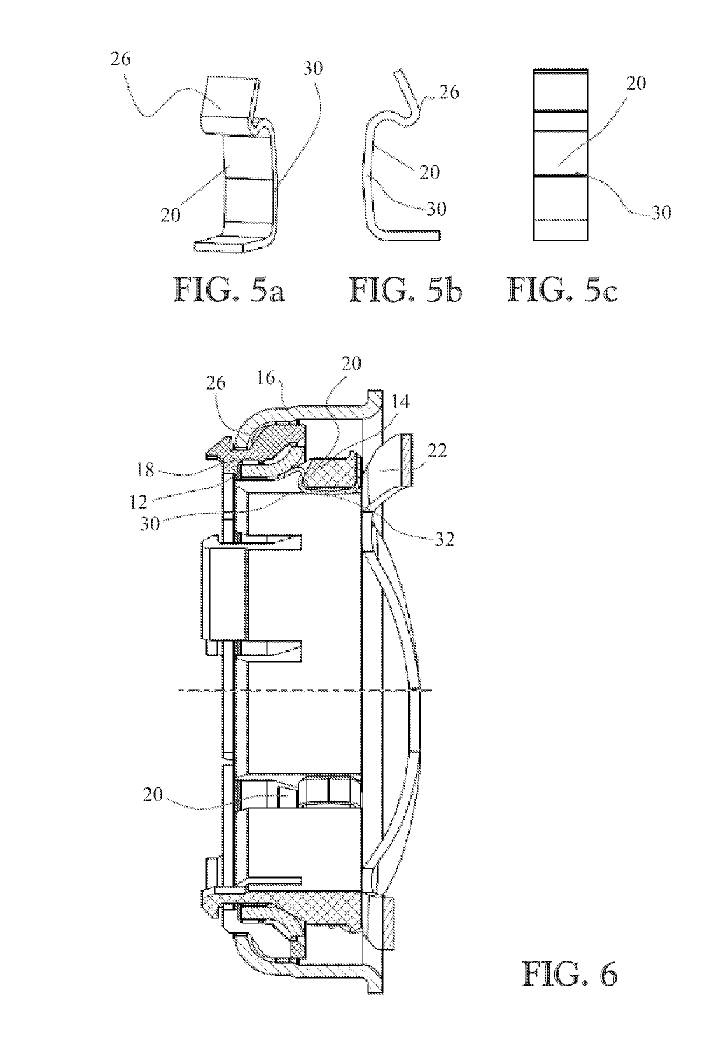

FIGS. 5-17 show further embodiments of the invention. The following description focuses on differences to the embodiment of FIGS. 1-4, whereas the reader should refer to the foregoing description of FIGS. 1-4 for the explanation of features which are essentially unchanged. Similar or identical features are provided with the same reference numbers in order to highlight the similarities.

FIGS. 5a-5c illustrate a clip-like conductive part 20 of the angular contact bearing assembly according to a second embodiment of the invention and FIG. 6 is a sectional view of the angular contact bearing assembly with the conductive parts 20 of FIG. 5a-5c. The characteristic feature of this embodiment is that the first flexible portion 26 contacting the conductive inner ring 12 is formed as a tongue protruding from one end of a C-shaped body part of the conductive part 20.

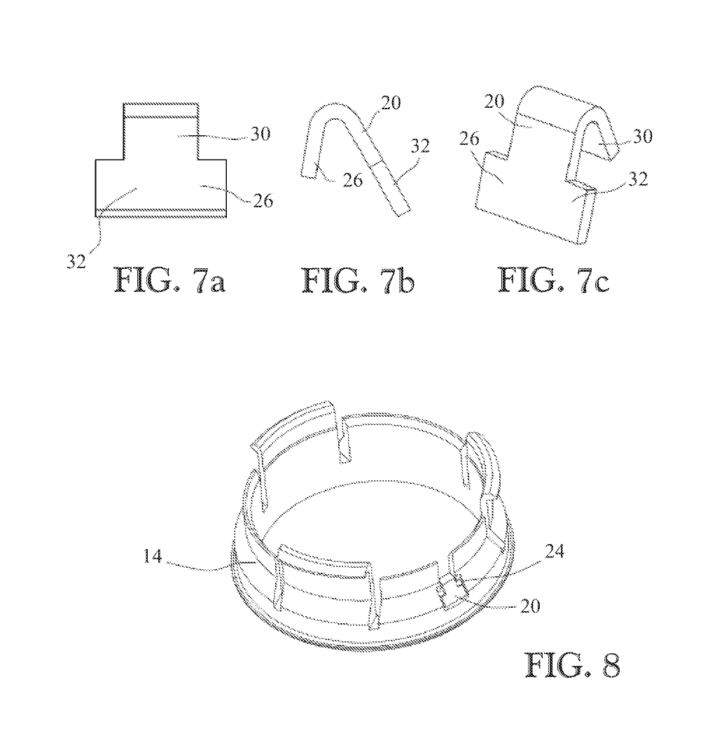

FIGS. 7a-7c illustrate a clip-like conductive part 20 of the angular contact bearing assembly according to a third embodiment of the invention and FIG. 8 is a sectional view of the angular contact bearing assembly with the conductive part 20 of FIGS. 7a-7c.

In the third embodiment, the conductive part 20 is mainly strip-shaped but is provided with an anchoring portion 34 in which the width of the strip is increased as compared to other portions of the conductive part 20. A recess 24 having a neck portion is provided in the sleeve 14. As shown in FIG. 8, width of the neck portion corresponds to the width of said other portions of the conductive part 20. More specifically, both the conductive part 20 and the recess 24 have a generally T-shaped structure wherein a transversal bar of this shape forms the anchoring portion 34. The recess 24 allows for some movement of the transversal bar in a direction perpendicular to the transversal bar forming the anchoring portion 34.

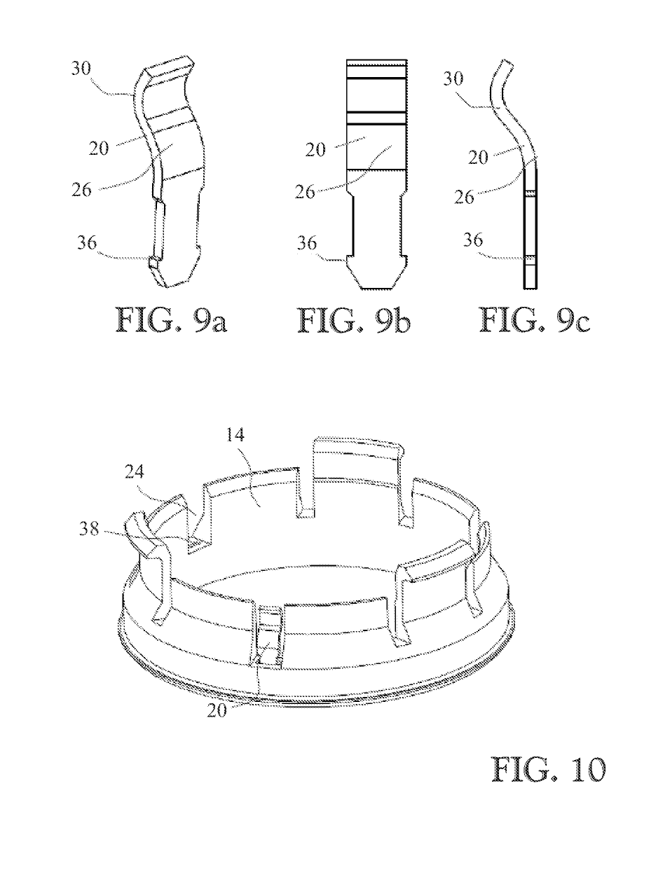

FIGS. 9a-9c, 10 and 11a-11c illustrate a fourth embodiment of the invention. The conductive parts 20 are formed as lengthy pins which may be inserted into pertinent slots 38 provided in the bottom of recesses 24 of a sleeve 14. The fixing portion of the conductive parts 20 is provided with barbs 36 engaging with the plastic material of the sleeve 14 such that an inseparable connection between the sleeve 14 and the conductive parts 20 is created.

The sleeve 14 is provided with recesses 24, from the bottom of which the conductive parts 20 protrude axially in an S-shape which is configured such that a first convex contacting portion 26 for directly contacting the inner ring 12 of the bearing assembly and a second convex contacting portion 30 for directly contacting the shaft 10 are created.

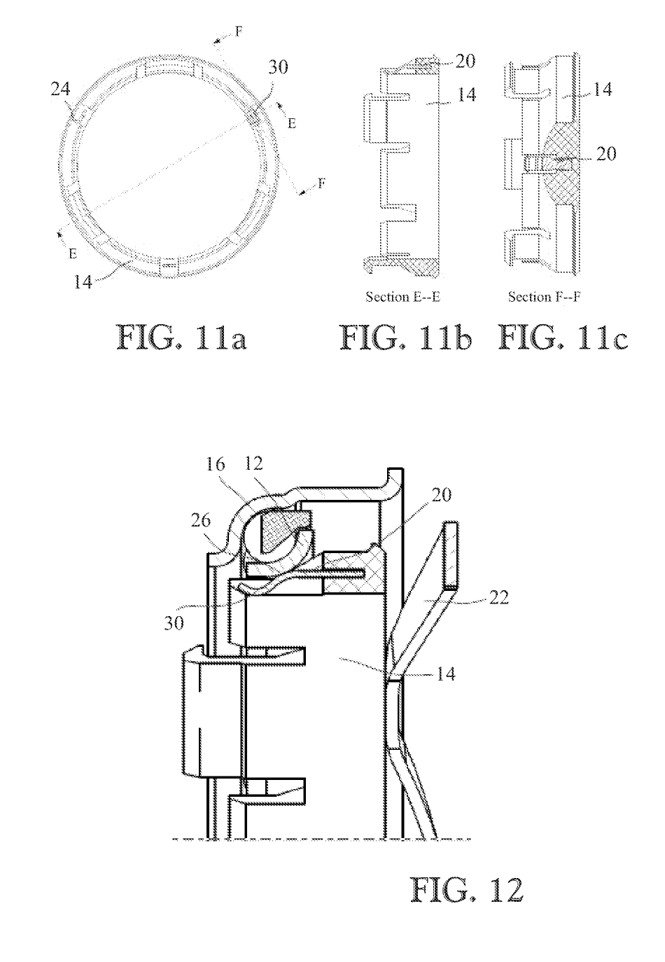

FIG. 11a is a top view of the sleeve 14 with the conductive parts 20 and FIGS. 11b and 11c are sectional views along the lines E-E and F-F in FIG. 11a respectively.

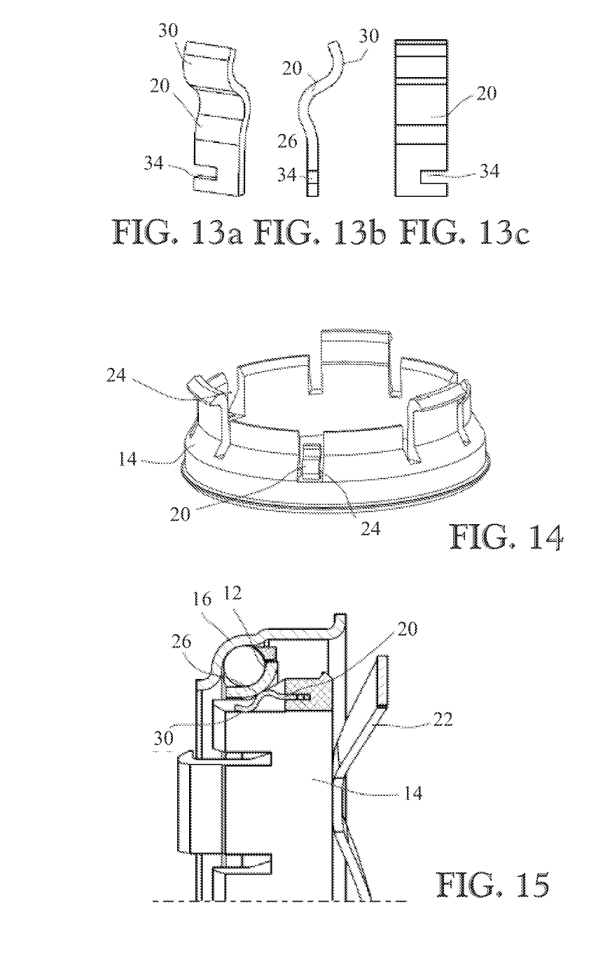

FIGS. 13a-13c, 14 and 15 illustrate a sixth embodiment of the angular contact bearing assembly with a conductive part 20, wherein the conductive part 20 is integrally molded or overmolded with the sleeve 14.

For manufacturing the sleeve 14, tongue-like conductive parts 20 as shown in FIGS. 13a-13c are arranged in a mold for molding the sleeve 14 in an injection molding process such that fixing- or anchoring portions 34 like holes in the conductive parts 20, which may be provided with barbs or a zigzag profile to improve the fixation, are immersed in the polymer material used when the latter sets. In the sixth embodiment of the invention, the anchoring portions 34 are formed as lateral cut-outs.

In further alternative embodiments, the contacting portions 26, 30 protrude from the plastic material of the sleeve 14 in different points.

As in the fourth embodiment, the sleeve 14 is provided with recesses 24, from the bottom of which the conductive parts 20 protrude axially in an S-shape which is configured such that a first convex contacting portion 26 for contacting the inner ring 12 of the bearing assembly and a second convex contacting portion 30 contacting the shaft 10 are created.

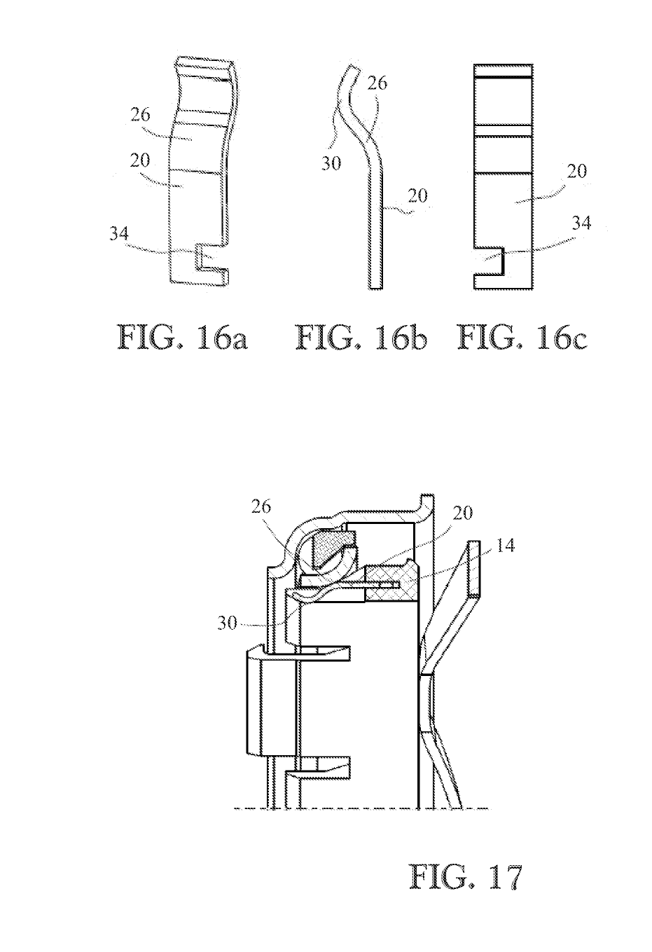

FIGS. 16a-16c and 17 illustrate a sixth embodiment of the angular contact bearing assembly with a conductive part 20, wherein the conductive part 20 is integrally molded or overmolded with the sleeve 14.

The only feature differing from the fifth embodiment of the invention is the shape of the protruding portion of the conductive part 20, which has a flatter shape which does not protrude axially over the axially outer surface of the anchoring portion 34 fixed in the bottom of the recess 24 of the sleeve.

What is claimed is:

1. An angular contact bearing assembly for use in a steering column, comprising:
at least one rolling bearing comprising conductive components;
a sleeve for mounting said at least one conductive rolling bearing on a shaft; and
a conductive part creating an electrically conductive contact between at least one of said conductive components of said at least one rolling bearing and said shaft,
wherein said conductive part has a circumferential extension of less than 360°.

2. The angular contact bearing assembly according to claim 1, wherein said at least one rolling bearing comprises:
a conductive inner ring with a concave recess forming a first raceway;
a conductive outer ring with a concave recess forming a second raceway;
a set of conductive rolling elements contacting both said first raceway and said second raceway.

3. The angular contact bearing assembly according to claim 1, wherein said conductive part has a circumferential extension of less than 5°.

4. The angular contact bearing assembly according to claim 1, wherein said conductive part is formed as a clip and said conductive part is snapped on a brim of said sleeve.

5. The angular contact bearing assembly according to claim 1, said sleeve further comprising a recess with a circumferential extension corresponding to said circumferential extension of said conductive part.

6. The angular contact bearing assembly according to claim 5, said recess comprises an axial recess in a brim of said sleeve.

7. The angular contact bearing assembly according to claim 1, said at least one rolling bearing further comprising multiple conductive parts distributed over a circumference of said sleeve.

8. The angular contact bearing assembly according to claim 7, said conductive part further comprising a generally C-shaped body part configured to be at least one of:
snapped on a brim and
into a recess of said sleeve,
wherein at least one of said first flexible portion and said second flexible portion is formed as a tongue protruding from one end of said body part.

9. The angular contact bearing assembly according to claim 1, said at least one rolling bearing further comprising a conductive inner ring; and
said conductive part further comprising a first flexible portion contacting said conductive inner ring,
wherein said first flexible portion is configured such that it is deformed and preloaded when fitting said conductive inner ring over said sleeve.

10. The angular contact bearing assembly according to claim 1, said conductive part further comprising a second flexible portion configured to contact said shaft, wherein said second flexible portion is configured such that it is deformed and preloaded when fitting said assembly including said sleeve and said conductive part over said shaft.

11. The angular contact bearing assembly according to claim 1, wherein said conductive part is generally strip-shaped and further comprises an anchoring portion in which a width of said strip is increased as compared to other portions of said conductive part,
said sleeve further comprising a recess having a neck portion, said width of said neck portion corresponding to a width of said other portions of said conductive part.

12. The angular contact bearing assembly according to claim 11, said conductive part has a generally T-shaped structure, wherein a transversal bar forms said anchoring portion.

13. The angular contact bearing assembly according to claim 1, further comprising a wavy spring abutting an axial end face of said sleeve in order to generate an axial preload of said angular contact bearing assembly, wherein said wavy spring is separate from said conductive part.

14. The angular contact bearing assembly according to claim 1, wherein said conductive part is integrally moulded with said sleeve.

15. A steering column for an automotive vehicle comprising:
a chassis with a mounting support,
a shaft; and
at least one angular contact bearing assembly mounted on said chassis mounting support and supporting said shaft, each of said at least one angular contact bearing assembly comprising:
at least one rolling bearing comprising conductive components;
a sleeve for mounting said at least one conductive rolling bearing on a shaft; and
a conductive part creating an electrically conductive contact between at least one of said conductive components of said at least one rolling bearing and said shaft,
wherein said conductive part has a circumferential extension of less than 360°.

16. The steering column according to claim 15, wherein said at least one rolling bearing further comprises:
a conductive inner ring with a concave recess forming a first raceway;
a conductive outer ring with a concave recess forming a second raceway;
a set of conductive rolling elements contacting both said first raceway and said second raceway.

17. The steering column according to claim 15, said at least one rolling bearing further comprising a conductive inner ring; and
said conductive part further comprising a first flexible portion contacting said conductive inner ring,
wherein said first flexible portion is configured such that it is deformed and preloaded
when fitting said conductive inner ring over said sleeve.

18. The steering column according to claim 15, wherein said sleeve further comprises a recess with a circumferential extension corresponding to said circumferential extension of said conductive part.

19. The steering column according to claim 15, further comprising with multiple conductive parts distributed over a circumference of said sleeve.

20. The steering column according to claim 15, wherein said conductive part is integrally moulded with said sleeve.
